(19) United States
(12) Patent Application Publication
(10) Pub. No.: US 2005/0254120 A1
(43) Pub. Date: Nov. 17, 2005

(54) Optical imaging system, in particular catadioptric reduction objective

(75) Inventors: Christoph Zaczek, Heubach (DE); Birgit Kurz, Aalen (DE); Jens Ullmann, Oberkochen (DE); Christian Wagner, Eersel (NL)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/066,923

(22) Filed: Feb. 28, 2005

Related U.S. Application Data
(63) Continuation of application No. PCT/EP03/09253, filed on Aug. 21, 2003.

(30) Foreign Application Priority Data
Aug. 27, 2002 (DE) 102 40 598.0

(51) Int. Cl. G02B 26/08

(52) U.S. Cl. 359/352; 359/483

(57) ABSTRACT

An optical reproduction system, which can be configured for example as a catadioptric projection lens. This system includes an optical axis and a first deflection mirror, which is tilted in relation to the optical axis at a given tilt angle. One of the deflection mirrors has a ratio Rₛₚ of the reflection coefficient Rₛ for s-polarised light to the reflection coefficient Rₚ for p-polarised light, in an incidence angle range that includes the tilt angle, of greater than one, whereas the corresponding ratio for the other deflection mirror is less than one. The deflection mirrors thus ensure that the polarization-dependant influence of the travel light remains minimal.

This application is a Continuation application of International Patent Application PCT/EP2003/09253 filed on Aug. 21, 2003 and claiming priority from German Patent Application 102 40 598.0 filed on Aug. 27, 2002. Priority is claimed from German Patent Application 102 40 598.0 filed on Aug. 27, 2002. The disclosure of both documents is incorporated herein by reference.

### BACKGROUND OF THE INVENTION

1. Field of the Invention

The invention relates to an optical imaging system, in particular a catadioptric projection objective, for projecting a pattern arranged in an object plane of the imaging system into the image plane of the imaging system.

2. Description of the Related Art

Catadioptric projection objectives are used in projection exposure systems for the production of semiconductor components and other finely structured components, especially in wafer scanners and wafer steppers. Their purpose is to project patterns of photomasks or lined plates, which will also be referred to below as masks or reticles, onto an object coated with a photosensitive layer with maximal resolution on a reducing scale.

In order to generate finer and finer structures, it is desirable on the one hand to increase the numerical aperture (NA) on the image side of the projection objective and, on the other hand, to use shorter and shorter wavelengths, preferably ultraviolet light with wavelengths of less than about 260 nm.

In this wavelength range, only a few sufficiently transparent materials are available for production of the optical components, in particular synthetic quartz glass and fluoride crystals such as calcium fluoride. Since the Abbe constants of the available materials are very close together, it is difficult to provide purely refractive systems that have sufficient correction of chromatic aberrations. For very high-resolution projection objectives, therefore, use is predominantly made of catadioptric systems in which refracting and reflecting components are combined, especially lenses and mirrors.

When imaging mirror surfaces are used, it is necessary to employ, devices for deflecting the beams in order to be able to achieve imaging without obscuration and vignetting. Besides systems which have physical beam splitters, especially ones with polarization-selectively effective mirror surfaces, systems with geometrical beam splitting by means of one or more fully reflective deflecting mirrors are known. Systems of this type have a first deflecting mirror which is tilted relative to the optical axis, which is used either to deflect the radiation coming from the object plane toward the concave mirror or in order to deflect the radiation reflected by the concave mirror toward downstream objective parts. A second deflecting mirror is generally provided, and is used as a folding mirror in order to parallelize the object plane and the image plane. In order to ensure that these mirrors have a high reflectivity, they are customarily coated with a reflective coating, usually multiple dielectric layers or a combination of metallic and dielectric layers. The light passing through can be influenced polarization-dependently by using dielectric layers which are operated with a high angle of incidence.

It has been found that, under certain imaging conditions in such catadioptric systems, various structure lines contained in the pattern to be imaged are projected with different contrast. These contrast differences for various structure directions are also referred to as H-V differences (horizontal-vertical differences) or as variations in the critical dimensions (CD variations) and can be observed as different line widths for the different structure directions in the photoresist.

Various proposals have been made for avoiding such direction-dependent contrast differences. EP 964 282 A2 addresses the problem that a privileged polarization direction is introduced when light passes through catadioptric projection systems with deflecting mirrors, which is due to the fact that the reflectivity of the multiply coated deflecting mirrors for s-polarized light is higher than for p-polarized light. Light which is still unpolarized in the reticle plane will therefore become partially polarized in the image plane, which is supposed to lead to a direction dependency of the imaging properties. This effect is counteracted by providing a polarization bias in the illumination system through the production of partially polarized light with a predetermined degree of residual polarization, which is compensated for by the projection optics so that unpolarized light emerges from its output.

DE 198 51 749 (which corresponds to EP 1 001 295) relates to a catadioptric projection objective with a geometrical beam splitter which has two mutually perpendicular deflecting mirrors. Polarization-dependent effects relating to beam geometry and phase, such as those due to differences in the reflection as a function of the polarization direction relative to the reflection plane, are compensated for in one embodiment by additional deflections at a deflecting mirror, in which the incidence plane is not coplanar with the incidence plane at the deflecting mirrors of the beam splitter but is oriented perpendicularly to it instead. In another embodiment, the deflecting mirror of the beam deflecting device carries thin phase-correcting dielectric layers which are intended to provide compensation for polarization-specific effects during the reflection at the deflecting mirror. No details are given about the structure of these layers.

### SUMMARY OF THE INVENTION

It is one object of the invention to provide an optical imaging system having at least two deflecting mirrors tilted relative to the optical axis, which prevents or avoids polarization-dependent effects due to the deflecting mirrors on the light passing through. It is another object to provide a catadioptric projection objective with a geometrical beam splitter, which allows imaging essentially without structure direction-dependent contrast differences for different structure directions of a pattern.

To address these and other objects, the invention, according to one formulation thereof, provides an optical imaging system for projecting a pattern arranged in an object plane of the imaging system into an image plane of the imaging system, comprising: an optical axis; a first deflecting mirror, which is tilted relative to the optical axis by a first tilt angle; and a second deflecting mirror, which is tilted relative to the optical axis by a second tilt angle;a ratio Rₛₚ between a reflectivity Rₛ of a deflecting mirror for s-polarized light and a reflectivity Rₚ of the deflecting mirror for p-polarized light being greater than one for one of the deflecting mirrors and less than one for the other deflecting mirror in an angle of incidence range comprising the tilt angle assigned to that deflecting mirror.

Preferred embodiments are specified in the dependent claims. The wording of all the claims is hereby incorporated by reference into the content of the description.

An optical imaging system which is used for projecting a pattern arranged in the object plane of the imaging system into the image plane of the imaging system, and which may in particular be configured as a catadioptric projection objective, has an optical axis, a first deflecting mirror which is tilted relative to the optical axis by a first tilt angle, and a second deflecting mirror which is tilted relative to the optical axis by a second tilt angle. Preferably, the deflecting mirrors are tilted about parallel tilt axes relative to the optical axis of the system, and are arranged so that the object plane and the image plane are aligned parallel. The deflecting mirrors are configured so that a ratio Rₛₚ between the reflectivity Rₛ of a deflecting mirror for s-polarized light and the reflectivity Rₚ of the deflecting mirror for p-polarized light is greater than one for one of the deflecting mirrors and less than one for the other deflecting mirror in an angle of incidence range comprising the assigned tilt angle.

Here, the tilt angle of the deflecting mirrors is defined as the angle between the optical axis at the deflecting mirror and the normal to the surface of the flat mirror surface. The angle of incidence is defined as the angle between the direction of light incidence on the deflecting mirror and the normal to the surface. For light incident parallel to the optical axis, the angle of incidence therefore corresponds to the tilt angle of the deflecting mirror. For light with an s-polarization, the electric field vector oscillates perpendicularly to the incidence plane which contains the incident direction and the normal to the surface of the deflecting mirror, while for p-polarized light the electric field vector oscillates parallel to this incidence plane.

The reflectivities of the mirrors for the different polarization directions are therefore configured so that one of two deflecting mirrors reflects the s-polarization more strongly than the p-polarization in the relevant angle of incidence range around the tilt angle, and so that the ratio of the reflectivities is reversed for the other deflecting mirror. This makes it possible to use the reflection at the second deflecting mirror in order to compensate at least partially for any change in the ratio of the reflected intensities for s- and p-polarization due to the first deflecting mirror. The effect achievable by this, for example, is that, when circularly polarized or unpolarized input light is used, the polarization state of the light becomes at least approximately circularly polarized or unpolarized again after twofold reflection by the deflecting mirrors, without a substantial privileged direction being created by the double reflection at the deflecting mirrors.

When conventional multi layer coatings are used on deflecting mirrors, the reflectivity for s-polarization throughout the angle range is known to be greater than for p-polarization, and large reflectivity differences can be encountered especially at the Brewster angle which ranges from about 54° to about 60°. When using conventional mirror technology for both deflecting mirrors, the p-component of the electric field will therefore be attenuated more strongly than the s-component, which can contribute to the aforementioned structure direction-dependent resolution differences. Since one of the deflecting mirrors in the imaging system according to the invention reflects p-polarization more strongly than s-polarization in the relevant angle of incidence range, however, partial or complete compensation for reflectivity differences can be achieved by the deflecting mirrors.

The invention may preferably be used for catadioptric projection objectives with geometrical beam splitters. In such projection objectives, a catadioptric objective part having a concave mirror and a first deflecting mirror, which is intended to deflect the radiation coming from the object plane toward the concave mirror or to deflect the radiation coming from the concave mirror toward the image plane, is arranged between the object plane and the image plane. A second, not functionally necessary deflecting mirror is then used to parallelize the object plane and the image plane. In typical embodiments, the first and second tilt angles lie in the range of 45°×15°, in particular 45°±10°. These preferred tilt angle ranges mean that the angles of incidence of the incident radiation also have their centroid around 45°±15°, that is to say close to or at least partially in the range of standard Brewster angles, where the differences between the reflectivities for s- and p-polarization are particularly large. The invention is therefore particularly useful for compensating for these differences here.

For the deflecting mirror with Rₛₚ>1, any suitable embodiment may be selected for the relevant wavelength range, for example a conventional mirror having a reflective metal layer and a dielectric coating of one or more dielectric layers applied on top, which can be used to enhance the reflection. According to one refinement, the other deflecting mirror which is intended to be more reflective for p-polarization in the relevant angle of incidence range (Rₛₚ<1) has a reflective coating with a metal layer and a dielectric layer arranged on the metal layer. In this case, the (geometrical) layer thickness d_{f} of the dielectric layer is selected so that the ratio Rₛₚ is less than one in an angle of incidence range comprising the tilt angle of the deflecting mirror.

The use of a metal layer which reflects the light being employed is highly advantageous for achieving a strongly reflective effect of the deflecting mirror over a large angle range. Especially for applications with wavelengths of 260 nm or less, it is favorable for the metal layer to consist essentially of aluminum. This material combines relatively high reflectivities with sufficient stability in relation to the energetic radiation. Other metals are also possible, for example magnesium, iridium, tin, beryllium or ruthenium. It has been found that the use of metal layers makes it possible to obtain simply constructed reflective coatings, which reflect the p-polarization component more strongly than the s-polarization component over a large angle range. The correct geometrical layer thickness d_{f} of the dielectric material is crucial in this context. It is generally found that for a given material combination of the metal layer and the dielectric layer, the reflectivities for p-polarization and s-polarization vary somewhat periodically and with partly conflicting trends and/or different amplitudes as a function of the layer thickness d_{f}, certain layer thickness ranges being distinguished in that the reflectivity Rₚ for p-polarization within them is greater than the reflectivity Rₛ for s-polarization.

Virtually absorption-free or even slightly absorbent dielectric materials may be used. When choosing slightly absorbent materials, care should be taken that they absorb only little of the light at the working wavelengths, so that the absorption does not noticeably impair the efficiency of the mirror. With suitable materials, the absorption coefficient k_{d} of the dielectric material may lie in the range k_{d}≦0.6, particularly in the range k_{d}≦0.01. Materials with k_{d}≦10⁻⁶ are referred to here as virtually absorption-free. The absorption coefficient k of a material is defined in this Application as being the imaginary part of the complex refractive index N=n−ik, where N is the complex refractive index, n is the real part of the refractive index and k is the imaginary part of the complex refractive index. The dimensionless absorption coefficient k, which is sometimes also referred to as the extinction coefficient, is related to the dimensional absorption coefficient α [1/cm] by the relation k=(αλ)/4π, where λ represents the corresponding wavelength of the light.

With working wavelengths of 157 nm, for example, the dielectric layer may essentially consist of one of the following materials or a combination of these materials: magnesium fluoride (MgF₂), aluminum fluoride (AlF₃), chiolite, cryolite, gadolinium fluoride (GdF₃), silicon dioxide (SiO₂), lanthanum fluoride (LaF₃) or erbium fluoride (ErF₃). All these materials are suitable for 193 nm, and furthermore aluminum oxide (Al₂O₃), for example. All the layer materials mentioned for 157 nm or 193 nm are suitable at 248 nm, and it is furthermore possible to use hafnium oxide (HfO₂), for example.

The selection of the correct layer thickness d_{f} of the dielectric layer for a given layer material, the predetermined wavelength and an intended angle of incidence range, may be carried out experimentally. Layer thicknesses for which the following condition is satisfied are particularly suitable:

$$0.3 \leq \frac{sin ( {ϕ}_{f} ( {ⅆ}_{f} , {α}_{0} ) )}{{N}_{f} \cdot cos ( {ⅆ}_{f} , {α}_{0} )} \leq 1.5 , \qquad ( 1 )$$

where φ_{f} is the phase thickness of the dielectric layer as a function of the layer thickness d_{f} and of the angle of incidence α₀, and N_{f} is the complex refractive index of the dielectric material. It follows, for example, that the value of the fraction in Eq. (1) preferably lies in the range of from about 1 to about 1.5 for a low-index material, while it preferably lies in the range of from about 0.3 to about 1 for high-index dielectric materials. The numerator and denominator of the function in Equation (1) may for example be about the same. There will be a more or less wide layer thickness range with Rₛₚ<1 around this point, depending on the angle of incidence in question, and it has been shown that the width of the layer thickness ranges and the difference between the reflectivities for s- and p-polarization tend to increase with greater angles of incidence.

Particularly favorable layer thicknesses lie in the vicinity of the first intersection of the aforementioned curves as a function of the phase thickness, since the angle of incidence range in which Rₛₚ<1 is particularly wide in this case. Relatively thin dielectric layers are therefore often favorable, for example with d_{f}<35 nm or d_{f}≦30 nm. Layer thicknesses in the vicinity of the higher-order intersections are also possible and, for example, may be used when the light strikes such a mirror in a small angle of incidence range.

The invention also relates to a mirror, in particular a mirror for ultraviolet light in a wavelength range shorter than 260 nm, having a mirror substrate and a reflective coating arranged on the mirror substrate, the reflective coating comprising a metal layer and a dielectric layer of dielectric material arranged on the metal layer, the layer thickness d_{f} of the dielectric layer being selected so that the ratio Rₛₚ is less than one in the angle of incidence range for which the mirror is intended. The mirror surface of the mirror may be flat, for example when the mirror is intended to be used as a deflecting mirror (or folding mirror). Mirrors with a curved mirror surface are also possible, i.e. convex mirrors or concave mirrors.

The inventors have discovered that the ratio Rₛₚ of the reflectivities for s- and p-polarization of a mirror can be deliberately adjusted through a suitable choice of the layer thickness d_{f} of a dielectric layer of essentially absorption-free or slightly absorbent material. Based on the invention, it is therefore possible to fabricate mirrors in which the reflectivities Rₛ and Rₚ are essentially equal or differ from each other by at most 10% or 5%, for example, at least for a predetermined angle of incidence or in a fairly narrow or wider angle of incidence range. Such polarization-neutral mirrors can be useful for many applications.

These and other features are disclosed by the claims as well as by the description and the drawings, and the individual features may respectively be implemented separately or together to form sub-combinations in embodiments of the invention and for other fields, and may constitute both advantageous and per se protective versions.

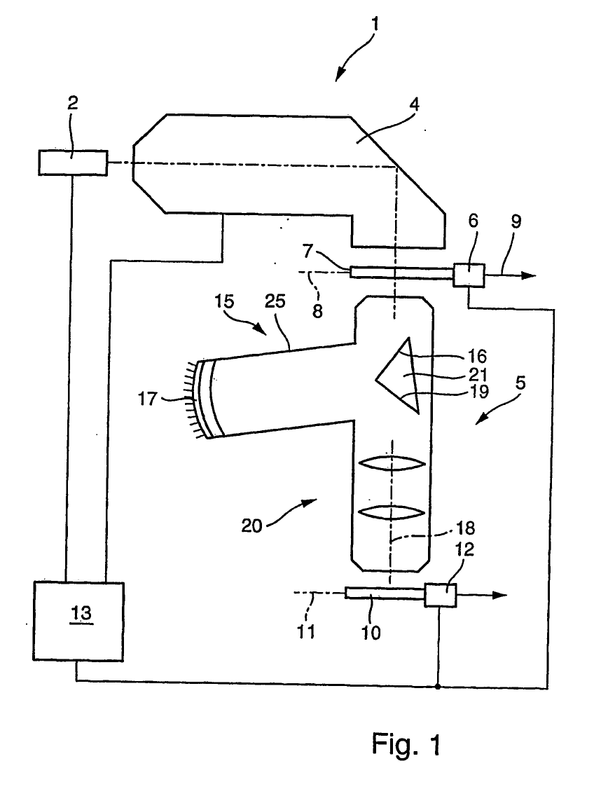

FIG. 1 is a schematic representation of a lithography projection exposure system, which comprises a catadioptric projection objective with a geometrical beam splitter according to one embodiment of the invention;

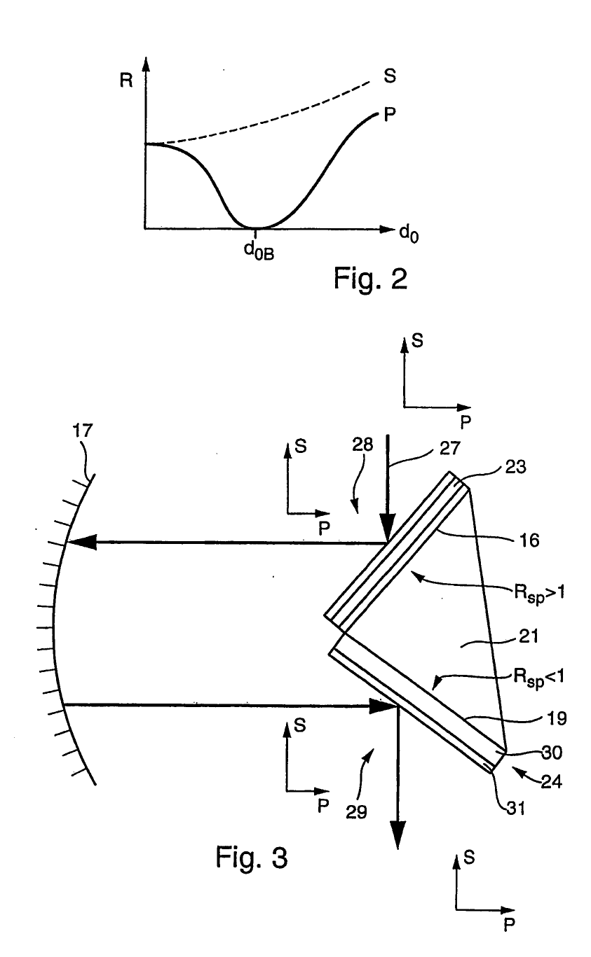

FIG. 2 is a diagram which schematically shows the dependence of the reflectivity R of a conventional mirror on the angle of incidence α₀ of the incident radiation for s- and p-polarized light;

FIG. 3 is a schematic detail view of the catadioptric objective part of the projection objective shown in FIG. 1;

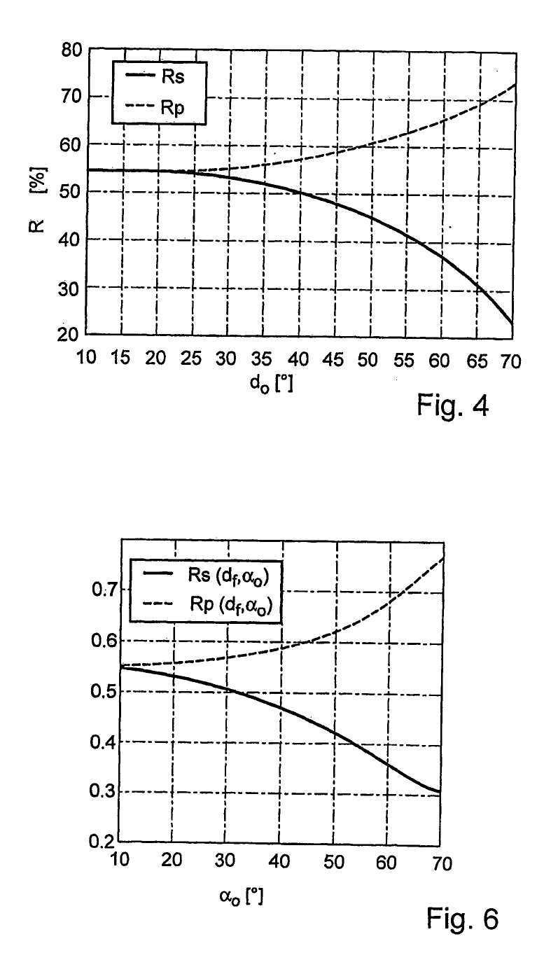

FIG. 4 is a diagram which shows measurements of the angle of incidence dependency of the reflectivities Rₚ and Rₛ for p- and s-polarized light at one of the deflecting mirrors, with Rₚ>Rₛ being satisfied in the angle of incidence range beyond about 20°;

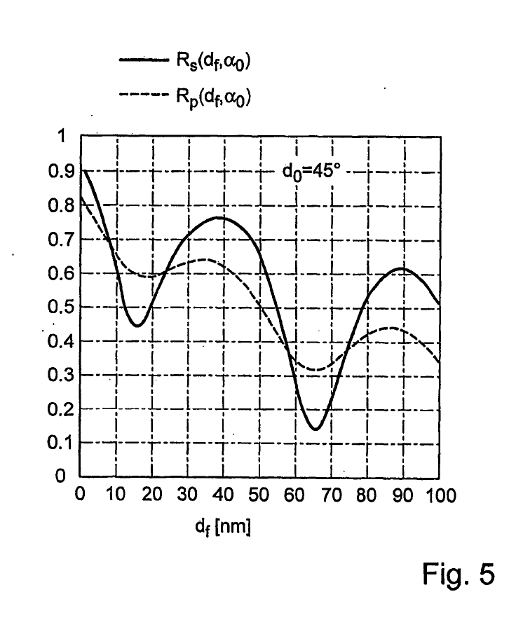

FIG. 5 is a calculated diagram which shows the dependency of the reflectivities Rₚ and Rₛ as a function of the layer thickness d_{f} of a reflective layer, in which a single layer of silicon dioxide is applied to an aluminum layer;

FIG. 6 is a diagram which shows values Rₚ and Rₛ calculated as a function of the angle of incidence for a reflective layer, the layer parameters of which correspond to the layer parameters of the reflective layer analyzed in FIG. 4.

FIG. 1 schematically shows a microlithography projection exposure system in the form of a wafer stepper 1, which is intended for the production of large-scale integrated semiconductor components. The projection exposure system comprises an excimer laser 2 as the light source, which emits ultraviolet light with a working wavelength of 157 nm, although in other embodiments this may be higher, for example 193 nm or 248 nm, or lower. A downstream illumination system 4 produces a large, sharply delimited and uniformly lit image field which is adapted to the telecentric requirements of the downstream projection objective 5. The illumination system has devices for selecting the illumination mode and, for example, can be switched between conventional illumination with a variable degree of coherence, ring field illumination and dipole or quadrupole illumination. Behind the illumination system, a device 6 for holding and manipulating a mask 7 is arranged so that the mask lies in the object plane 8 of the projection objective and can be moved in this plane in a traveling direction 9 (the y direction) by means of a scan drive for scanner operation.

The mask plane 8 is followed by the projection objective 5, which acts as a reduction objective and projects an image of a pattern arranged on the mask with a reduced scale, for example a scale of 1:4 or 1:5, onto a wafer 10 coated with a photoresist layer, which is arranged in the image plane 11 of the reduction objective. Other reduction scales are possible, for example stronger reductions of 1:20 or 1:200. The wafer 10 is held by a device 12, which comprises a scanner drive for moving the wafer synchronously with and parallel to the reticle 7. All the systems are controlled by a control unit 13.

The projection objective 5 operates with geometrical beam splitting, and it has a catadioptric objective part 15 with a first deflecting mirror 16 and a concave mirror 17 between its objective plane (the mask plane 8) and its image plane (the wafer plane 11), the flat deflecting mirror 16 being tilted relative to the optical axis 18 of the projection objective so that the radiation coming from the object plane is deflected or deviated in the direction of the concave mirror 17 by the deflecting mirror 16. In addition to this mirror 16, which is necessary for the function of the projection objective, a second flat deflecting mirror 19 is provided which is tilted relative to the optical axis so that the radiation reflected by the concave mirror 17 is deflectedd in the direction of the image plane 11 to the lenses of the downstream dioptric objective part 20 by the deflecting mirror 19. The mutually perpendicular flat mirror surfaces 16, 19 are provided on a beam deflecting device 21 designed as a mirror prism, and they have parallel tilt axes perpendicular to the optical axis 18.

The concave mirror 17 is fitted in an obliquely placed side arm 25. The oblique placement of the side arm can, inter alia, provide a sufficient working distance on the mask side over the entire width of the objective. Accordingly, the tilt angle of the deflecting mirrors 16, 19, the planes of which are mutually perpendicular, relative to the optical axis 18 can deviate from 45° and several degrees, for example from ±2° to ±10°. In other embodiments, the tilt angle of the deflecting mirror is 45°.

In the example shown, the catadioptric objective part is configured so as to produce an intermediate image in the vicinity of the second deflecting mirror 19, which image preferably does not coincide with the mirror plane but may lie slightly behind or in front in the direction of the concave mirror 17. Embodiments without an intermediate image are also possible. Furthermore, it is possible to design the mirrors 16, 19 as physically separated mirrors.

The mirror surfaces of the deflecting mirrors 16, 19 are coated with highly reflecting reflective layers 23, 24 in order to achieve high reflectivities. The reflective layer 23 of the first deflecting mirror may be constructed conventionally. For example, an aluminum layer is applied to a mirror substrate and a multilayer dielectric system is applied on top in order to enhance the reflection. Layers of this type are known per se, for example from U.S. Pat. No. 4,856,019, U.S. Pat. No. 4,714,308 or U.S. Pat. No. 5,850,309. It is also possible to use reflective layers having a metal layer, for example an aluminum layer, and a single protective dielectric layer applied on top, for example a layer of magnesium fluoride. Such layer systems are also described in the cited documents.

Such conventional layer systems are known to have different reflectivities for s- and p-polarization. A profile of the reflectivity R as a function of the angle of incidence α₀, which is typical of a simple system (metal/single dielectric layer), is schematically shown in FIG. 2. Accordingly, the reflectivities for s- and p-polarization with normal incidence (angle of incidence 0°) are equal. As the angle of incidence increases, the reflectivity for s-polarization increases monotonically while the reflectivity for p-polarization first decreases owing to the Brewster angle, before increasing again with further obliquity of the angle of incidence. With conventional reflective layers, therefore, the reflectivity for s-polarization is generally greater over the entire angle range than for p-polarization, particularly strong reflectivity differences being encountered in the range between about 45° and about 80°.

In conventional projection objectives with the geometrical beam splitting presented by way of example, this may mean that the p-component of the electric field is attenuated more strongly than the s-component when passing through the objective so that, for example with unpolarized or circularly polarized light on the input side, the light arriving in the image plane has a stronger s-component. This can cause structure direction-dependent resolution differences.

These problems are avoided in the embodiment as shown since the reflective layer 24 of the second deflecting mirror has a substantially higher reflectivity for p-polarized light in the relevant angle of incidence range around about 45° than for s-polarization, so that the ratio Rₛₚ<1.

In order to produce the mirror, an optically thick aluminum layer 30 with a layer thickness of about 65 nm to 100 nm is applied to the mirror substrate which consists of a material having a low coefficient of thermal expansion. The aluminum layer is covered with a single layer 31 of silicon dioxide with a layer thickness of about 15 nm. With the aid of this deflecting mirror, it is possible to compensate partially or fully for the privilege of the s-polarization due to the first deflecting mirror, since the s-component is reflected much more weakly than the p-component of the light by this mirror.

In order to explain this effect, FIG. 3 shows an example in which the input light 27 striking the first deflecting mirror 16 is circularly polarized, the amplitudes of s- and p-polarization as symbolized by the arrow lengths being essentially equal. After reflection by the first obliquely placed mirror 16, the electric field component oscillating parallel to the incidence plane is attenuated more strongly than the s-component. This partially polarized light propagates in the direction of the concave mirror 17. After reflection by the concave mirror 17, during which the polarization state remains substantially unaltered, the reflected light strikes the second deflecting mirror 19. At the latter, the p-component is now reflected more strongly than the (stronger) s-component owing to the reflectivity differences (Rₚ>Rₛ) explained with reference to FIG. 4, so that balancing of the amplitudes for s- and p-polarization is obtained. The multiple layers 23 and 24 are expediently configured so that there are essentially equal amplitudes of s- and p-polarization after the second deflecting mirror 16. With this light, it is possible to obtain imaging without structure direction-dependent contrast differences.

The reflective layer system 24 of the second deflecting mirror 19 is distinguished, inter alia, in that a dielectric layer 31 whose layer thickness has been deliberately optimized to achieve Rₚ>Rₛ is applied to the slightly absorbent metal layer 30. The way in which such layer thickness optimization is generally possible for a given material combination will be indicated below. The reflectivity Rₛ for s-polarized light, dependent on the layer thickness d_{f} and the angle of incidence α₀, is obtained from the reflection coefficient rₛ for this light according to the following equation:
Rₛ(α₀,d_{f})=rₛ(α₀, d_{f})·\overline{rₛ(α₀, d_{f})} (2),
where the horizontal bar denotes the complex conjugate of the value. The corresponding reflection coefficient for the s-component is calculated as follows: Equation (3)

$${r}_{s} ( {α}_{0} , {d}_{f} ) = \frac{{N}_{fs} ( {α}_{0} ) \cdot [ {n}_{0 s} ( {α}_{0} ) - {N}_{As} ( {α}_{s} ) ] \cdot cos ( {ϕ}_{f} ( {α}_{0} , {d}_{f} ) ) + i \cdot [ {n}_{0 s} ( {α}_{0} ) \cdot {N}_{As} ( {α}_{0} ) - {( {N}_{fs} ( {α}_{0} ) )}^{2} ] \cdot sin ( {ϕ}_{f} ( {α}_{0} , {d}_{f} ) )}{{N}_{fs} ( {α}_{0} ) \cdot [ {n}_{0 s} ( {α}_{0} ) + {N}_{As} ( {α}_{0} ) ] \cdot cos ( {ϕ}_{f} ( {α}_{0} , {d}_{f} ) ) + i \cdot [ {n}_{0 s} ( {α}_{0} ) \cdot {N}_{As} ( {α}_{0} ) + {( {N}_{fs} ( {α}_{0} ) )}^{2} ] \cdot sin ( {ϕ}_{f} ( {α}_{0} , {d}_{f} ) )}$$

Corresponding expressions are obtained for the reflectivity Rₚ and the reflection coefficient rₚ for the p-component:
Rₚ(α₀,d_{f})=rₚ(α₀,d_{f})·\overline{rₚ(α₀,d_{f})} (4),
and Equation (5):

$${r}_{p} ( {α}_{0} , {d}_{f} ) = \frac{{N}_{fs} ( {α}_{0} ) \cdot [ {n}_{0 p} ( {α}_{0} ) - {N}_{Ap} ( {α}_{0} ) ] \cdot cos ( {ϕ}_{f} ( {α}_{0} , {d}_{f} ) ) + i \cdot [ {n}_{0 p} ( {α}_{0} ) \cdot {N}_{Ap} ( {α}_{0} ) - {( {N}_{fp} ( {α}_{0} ) )}^{2} ] \cdot sin ( {ϕ}_{f} ( {α}_{0} , {d}_{f} ) )}{{N}_{fp} ( {α}_{0} ) \cdot [ {n}_{0 p} ( {α}_{0} ) + {N}_{As} ( {α}_{0} ) ] \cdot cos ( {ϕ}_{f} ( {α}_{0} , {d}_{f} ) ) + i \cdot [ {n}_{0 p} ( {α}_{0} ) \cdot {N}_{Ap} ( {α}_{0} ) + {( {N}_{fp} ( {α}_{0} ) )}^{2} ] \cdot sin ( {ϕ}_{f} ( {α}_{0} , {d}_{f} ) )}$$

In the equations, the values N_{fp} and N_{fs} represent the effective refractive indices of the dielectric layer for p- and s-polarization, the terms n₀ₚ and n₀ₛ represent the effective refractive indices of the surrounding medium, the terms N_{Ap} and N_{As} represent the effective refractive indices of the metal layer and the expression Φ_{f} (d_{f}, α₀) represents the phase thickness of the dielectric layer. For the phase thickness, the following applies:

$${ϕ}_{f} ( {d}_{f} , {α}_{0} ) = 2 \cdot \frac{π}{{λ}_{0}} \cdot {d}_{f} \cdot {N}_{f} \cdot \sqrt{1 - {n}_{0}^{2} \cdot \frac{{sin}^{2} ( {α}_{0} )}{{N}_{f}^{2}}} . \qquad ( 6 )$$

The effective refractive indices Nₛ or Nₚ for s- and p-polarization are generally calculated according to:
Nₛ(α₀)=\sqrt{N²−n₀²·sin²(α₀)} (7)
and

$${N}_{p} ( {α}_{0} ) = \frac{{N}^{2}}{{N}_{s} ( {α}_{0} )} , \qquad ( 8 )$$

where the values N respectively indicate the complex refractive index of a material according to N=n−ik. Here, n is the real part and k is the imaginary part of the complex refractive index of the medium in question. In all the formulae, the index A stands for the substrate material (aluminum in the example) and f stands for the dielectric layer.

For the example system, if the optical constants of the silicon dioxide layer are now set to n_{f}=1.685 and k_{f}=0.055, and the optical constants of the aluminum substrate are set to n_{A}=0.143 and k_{A}=1.73, then the layer thickness dependency as shown in FIG. 5 is obtained for the reflectivities Rₛ and Rₚ with an angle of incidence of 45°. It can be seen that the reflectivities Rₛ and Rₚ both approximately vary periodically as the layer thickness d_{f} increases, the variation amplitude being greater for Rₛ than for Rₚ. The curves intersect many times, so that there are many layer thickness ranges in which Rₚ is greater than Rₛ. A first such range is at a layer thickness of between about 10 nm and about 25 nm, the range with the maximum difference being at about 15 nm. A second range lies between about 60 and 75 nm, the greatest difference being at about 67 nm. It can also be seen that the absolute values of the reflectivities tend to decrease as the layer thickness increases. This is essentially attributable to the slight absorption by the dielectric layer material, i.e. silicon dioxide, at the chosen wavelength (157 nm). The calculation shows that with a layer thickness of about 15 nm, it is possible to obtain a reflective layer in which the reflectivity Rₚ for p-polarization is from about 10% (at about 45°) to about 30% (at about 60^{o}) greater than the reflectivity Rₛ for s-polarization. Here, Rₛₚ<0.8.

If the dependence of the reflectivities Rₛ and Rₚ on the angle of incidence is considered for the system being calculated, then the dependency as represented in FIG. 6 is obtained. It can be seen that for a system with a given layer thickness d_{f} of the dielectric layer, the differences between the stronger reflectivity of p-polarization and the weaker reflectivity for s-polarization increase as the angle of incidence becomes greater.

Comparison of the theoretical curves in FIG. 6 with reflectivities in FIG. 4, as determined using the system actually fabricated, shows a very good qualitative match, with the absolute values indicated for the reflectivities showing a significant match.

In an exemplary system which is not represented in the drawings, the reflective system consists of an optically thick aluminum layer to which a single layer of magnesium fluoride, which is virtually absorption-free (k_{f}=0) and has a real refractive index n_{f}=1.48 at a wavelength of 157 nm, is applied. The optical constants of the metal layer are assumed to be n_{A}=0.072 and k_{A}=1.66. The optical constants of the metal layer generally depend on the coating method and, for example, may also assume the values mentioned above in connection with the SiO₂ layer.

With this reflective layer at an angle of incidence of 45°, the condition Rₛ<Rₚ is satisfied in the thickness range of from about 15 nm to about 24 nm. This range becomes wider when moving to higher angles of incidence. With an angle of incidence of 60°, for example, the condition Rₛ<Rₚ is satisfied in the thickness range of from about 13 nm to about 33 nm. This means that for the important angle of incidence range around about 45°, for example between 40° and 50°, particularly favorable layer thicknesses lie in the range of between about 15 nm and about 30 nm. Similarly as in FIG. 5, higher-order layer thickness ranges are also possible. A disadvantage of higher-order layer thickness ranges is generally that the condition Rₚ>Rₛ is satisfied only over a comparatively small angle of incidence range. For this reason, inter alia, small layer thicknesses from the first respective layer thickness ranges with Rₚ>Rₛ are preferable.

The invention has been explained with reference to specific exemplary embodiments. Being provided with the ideas on which the invention is based and corresponding formulae, the person skilled in the art will be able to generalize this to many other systems suitable for a particular working wavelength range. A check as to whether a given material combination of the metal layer and the dielectric layer is suitable for achieving Rₚ>Rₛ is readily possible with the aid of the above explanations.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all changes and modifications as fall within the spirit and scope of the invention, as defined by the appended claims, and equivalents thereof.

1. An optical imaging system for projecting a pattern arranged in an object plane of the imaging system into an image plane of the imaging system, comprising:
an optical axis;
a first deflecting mirror, which is tilted relative to the optical axis by a first tilt angle; and
a second deflecting mirror, which is tilted relative to the optical axis by a second tilt angle;
wherein a ratio Rₛₚ between a reflectivity Rₛ of a deflecting mirror for s-polarized light and a reflectivity Rₚ of a deflecting mirror for p-polarized light is greater than one for one of the deflecting mirrors and less than one for the other of the deflecting mirrors in an angle of incidence range comprising the tilt angle assigned to that deflecting mirror.

2. The optical imaging system as claimed in claim 1, wherein the first tilt angle and the second tilt angle lie in a range of 45°×15°.

3. The imaging system as claimed in claim 1, wherein the ratio Rₛₚ is less than at least one of 0.8 and 0.9 for one of the deflecting mirrors at an angle of incidence corresponding to the tilt angle assigned to that deflecting mirror.

4. The imaging system as claimed in claim 1, wherein the optical imaging system is a catadioptric projection objective in which a catadioptric objective part having a concave mirror and the first deflecting mirror, which is arranged to deflect the radiation coming from the object plane toward the concave mirror or to deflect the radiation coming from the concave mirror toward the image plane, is arranged between the object plane and the image plane.

5. The imaging system as claimed in claim 4, wherein the second deflecting mirror is oriented perpendicularly to the first deflecting mirror, so that the object plane and the image plane are aligned parallel with each other.

6. The imaging system as claimed in claim 1, wherein one of the deflecting mirrors has a reflective coating, which comprises a metal layer and a dielectric layer of dielectric material arranged on the metal layer, a layer thickness d_{f} of the dielectric layer being selected so that the ratio Rₛₚ is less than one in an angle of incidence range comprising the tilt angle of the deflecting mirror.

7. The imaging system as claimed in claim 6, wherein the metal layer consists essentially of aluminum.

8. The imaging system as claimed in claim 6, wherein the dielectric layer is a single layer.

9. The imaging system as claimed in claim 6, wherein the dielectric material is essentially absorption-free at a working wavelength of the imaging system.

10. The imaging system according to claim 6, wherein the dielectric material is slightly absorbent at a working wavelength of the optical system, an absorption coefficient k of the dielectric material being at least one of less than 0.6 and less than 0.01 at the working wavelength.

11. The imaging system as claimed in claim 6, wherein the dielectric layer consists essentially of one of the following materials or a combination of these materials: magnesium fluoride (MgF₂), aluminum fluoride (AlF₃), chiolite, cryolite, gadolinium fluoride (GdF₃), silicon dioxide (SiO₂), hafnium oxide (H_{f}O₂), aluminum oxide (Al₂O₃), lanthanum fluoride (LaF₃) or erbium fluoride (ErF₃).

12. The imaging system as claimed in claim 6, wherein the layer thickness d_{f} of the dielectric layer is selected so that the following condition is satisfied:
$$0.3 \leq \frac{sin ( {ϕ}_{f} ( {ⅆ}_{f} , {α}_{0} ) )}{{N}_{f} \cdot cos ( {ϕ}_{f} ( {ⅆ}_{f} , {α}_{0} ) )} \leq 1.5 ,$$
where Φ_{f} is the phase thickness of the dielectric layer as a function of the layer thickness d_{f} and of the angle of incidence α₀, and N_{f} is the complex refractive index of the dielectric material.

13. The imaging system as claimed in claim 1, which is designed for ultraviolet light having a wavelength of less than 260 nm.

14. A mirror for ultraviolet light comprising a mirror substrate and a reflective coating arranged on the mirror substrate, the reflective coating comprising a metal layer and a dielectric layer of dielectric material arranged on the metal layer, a layer thickness d_{f} of the dielectric layer being selected so that the ratio Rₛₚ between the reflectivity Rₛ of the mirror for s-polarized light and the reflectivity Rₚ of the mirror for p-polarized light is less than one in an angle of incidence range of the mirror.

15. The mirror as claimed in claim 14, wherein the angle of incidence range lies in the range of 45°±15°.

16. The mirror as claimed in claim 14, wherein the metal layer consists essentially of aluminum.

17. The mirror as claimed in claim 14, wherein the dielectric layer is a single layer.

18. The mirror as claimed in claim 14, wherein the dielectric layer consists essentially of one of the following materials or a combination of these materials: magnesium fluoride (MgF₂), aluminum fluoride (AlF₃), chiolite, cryolite, gadolinium fluoride (GdF₃), silicon dioxide (SiO₂), hafnium oxide (H_{f}O₂), aluminum oxide (Al₂O₃), lanthanum fluoride (LaF₃) or erbium fluoride (ErF₃).

19. The mirror as claimed in claim 14, wherein the layer thickness d_{f} of the dielectric layer is selected so that the following condition is satisfied:
$$0.3 \leq \frac{sin ( {ϕ}_{f} ( {ⅆ}_{f} , {α}_{0} ) )}{{N}_{f} \cdot cos ( {ϕ}_{f} ( {ⅆ}_{f} , {α}_{0} ) )} \leq 1.5 ,$$
where Φ_{f} is the phase thickness of the dielectric layer as a function of the layer thickness d_{f} and of the angle of incidence α₀, and N_{f} is the complex refractive index of the dielectric material.

20. The mirror as claimed in claim 14, which is designed for ultraviolet light having a wavelength of less than 260 nm.

21. A mirror comprising:
a mirror substrate; and
a reflective coating arranged on the mirror substrate;
the reflective coating being effective for ultraviolet light having a wavelength of less than 260 nm in a predefined angle of incidence range of light impinging on the mirror;
the reflective coating comprising a metal layer and a single dielectric layer of dielectric material arranged on the metal layer;
wherein a layer thickness d_{f} of the dielectric layer is selected so that the following condition is satisfied:
$$0.3 \leq \frac{sin ( {ϕ}_{f} ( {ⅆ}_{f} , {α}_{0} ) )}{{N}_{f} \cdot cos ( {ϕ}_{f} ( {ⅆ}_{f} , {α}_{0} ) )} \leq 1.5 ,$$
where Φ_{f} is the phase thickness of the dielectric layer as a function of the layer thickness d_{f} and of the angle of incidence α₀, and N_{f} is the complex refractive index of the dielectric material,
whereby a ratio Rₛₚ between the reflectivity Rₛ of the mirror for s-polarized light and the reflectivity Rₚ of the mirror for p-polarized light is less than one in the angle of incidence range of the mirror.

22. The mirror as claimed in claim 21, wherein the angle of incidence range lies in the range of 45°±15°.

23. The mirror as claimed in claim 21, wherein the dielectric layer consists essentially of one of the following materials or a combination of these materials: magnesium fluoride (MgF₂), aluminum fluoride (AlF₃), chiolite, cryolite, gadolinium fluoride (GdF₃), silicon dioxide (SiO₂), hafnium oxide (H_{f}O₂), aluminum oxide (Al₂O₃), lanthanum fluoride (LaF₃) or erbium fluoride (ErF₃).
